(19) United States
(12) Patent Application Publication
(10) Pub. No.: US 2022/0405028 A1
(43) Pub. Date: Dec. 22, 2022

(54) PASSCODES-BASED PRINTING

(71) Applicant: Hewlett-Packard Development Company, L.P., Spring, TX (US)

(72) Inventors: Arabinda Choudhary, Bangalore (IN); Satya Ranjan Rath, Bangalore (IN); Dibyajivan Das, Bangalore (IN); Sonu Lukose, Bangalore (IN); Praveen Prakash Thazhathu Pullaikudi, Bangalore (IN); Hrudayasri Vatsalya Kedarisetty, Bangalore (IN)

(21) Appl. No.: 17/649,936

(22) Filed: Feb. 4, 2022

(30) Foreign Application Priority Data
Jun. 16, 2021 (IN) 202141021952

(51) Int. Cl. G06F 3/12

(52) U.S. Cl. CPC G06F 3/1222; G06F 3/1238

(57) ABSTRACT

An example pull-print server may include a processor and a memory coupled to the processor. The memory may include a receiving unit to receive a print job including variable print data, a reference identifier, and a passcode specific to the print job. Further, the memory may include a mapping unit to identify a template corresponding to the reference identifier and store mapping information that maps the variable print data and the passcode to the identified template. Furthermore, the memory may include a controller to receive, via a printer, a pull print request including the passcode. In response to receiving the pull print request, the controller may retrieve the variable print data and the stored template corresponding to the passcode using the mapping information. Further, the controller may generate print content by overlaying the variable print data onto the identified template and transmit the print content to the printer.

### BACKGROUND

Image forming apparatuses, such as printers, may be capable of printing documents on print media (e.g., papers). Some printers may support a pull printing feature, where a pull-print server (e.g., a cloud server) may receive a print job including print data from a user account and store the print job. Further, when a user inputs a pull-print request through a printer, the printer may receive the print job from the pull-print server and perform printing. In an enterprise environment, multiple users may access such printers to print same or different documents.

### BRIEF DESCRIPTION OF THE DRAWINGS

Examples are described in the following detailed description and in reference to the drawings, in which:

FIG. 1A is a block diagram of an example pull-print server to generate print content for printing based on a passcode;

FIG. 1B is a block diagram of the example pull-print server of FIG. 1A, depicting additional features;

FIG. 2A is a flowchart illustrating an example method for generating a print job with an associated passcode;

FIG. 2B is a flowchart illustrating an example method for generating print content in response to a request to release the print job with the associated passcode;

FIG. 3A is a flowchart illustrating another example method for generating a print job with an associated passcode;

FIG. 3B is a flowchart illustrating an example method for generating print content in response to a request to release the print job with the associated passcode;

FIG. 4 is a flowchart illustrating an example method for selectively generating a first version or a second version of a document for printing based on a corresponding passcode;

FIG. 5A is a flowchart illustrating an example method for providing different versions of a document and associated passcodes to a pull-print server;

FIG. 5B is a flowchart illustrating an example method for storing the different versions of the document of FIG. 5A for printing based on the associated passcodes;

FIG. 6 is a block diagram of an example printer including non-transitory machine-readable storage medium storing instructions to store a document for printing by mapping to multiple passcodes and multiple user accounts;

FIG. 7A is a flowchart illustrating an example method for storing a document by mapping to multiple passcodes and multiple user accounts; and

FIG. 7B is a flowchart illustrating an example method for executing a print job in response to a request to release the print job with an associated passcode.

### DETAILED DESCRIPTION

In an enterprise environment, multiple computing devices (e.g., client devices) may be connected to image forming apparatuses (e.g., printers) over a network. Pull printing may refer to a printing feature where a print job can be held on a pull-print server (e.g., server-based pull printing) or on a client device/printer (e.g., serverless pull printing) and released by a user at a printer, which supports the printing feature. In server-based pull printing, the print job initiated from the client device is sent to the pull-print server. Further, the printer may receive the print job from the pull-print server and perform printing when the user inputs a print request through the printer. In this example, the user authenticates the print job at the printer using security measures, such as personal identification number (PIN), a password, a smartcard, or the like, to release the print job. Similarly, in serverless pull printing, the print job may be held on the client device or the printer until released by the user.

An example print job may include an electronic document to be printed. In some examples, the electronic document may be password-protected such that the electronic document may require a password (e.g., entered by the user) before they can be accessed (e.g., viewed, edited, printed, and the like). For example, to print a password-protected document, the user may open the document with an appropriate application and then provide the password in response to a prompt or other notification request for the password. Once the document has been opened, the user may print the document (e.g., by selecting a printer connected to the computing device hosting the application and generating the print job for that printer).

In some examples, different parts of a single document may include varying degrees of sensitivity. For example, consider a first document including static data and variable data specific to a first user, and a second document including the same static data and variable data specific to a second user. In this example, when the first and second documents are to be printed, two different print jobs may have to be submitted to the printer or the pull-print server. Further, multiple documents may have to be stored against corresponding user accounts, where the static data is duplicated.

In other examples, a user may have to print different versions of a same document. Each of the different versions of the document may include slight or delta change when compared to other versions of the document. In such a scenario, the user may have to submit multiple print jobs, each print job including a version of the document for printing. Further, the pull-print server or the printer may have to store different versions of the document corresponding to each print job separately, which may consume a significant amount of storage space.

In some other examples, each print job received by the pull-print server or the printer may be stored against respective user's account. For example, when a same print job is initiated by two different users, content (e.g., a document) to be printed may be duplicated in the pull-print server. Consider a team of four members in an organization and they may have to print a same document prior to a meeting. When the four members initiate the print job, the print job may be stored four times in the pull-print server (i.e., a copy of the document to be printed may be stored against each member's account).

Examples described herein may provide a pull-print server that may provide passcodes-based printing of documents. In an example, the pull-print server may receive a print job via a print driver of a client device. The print job may include variable print data (i.e., data specific to a user), a reference identifier (i.e., associated with a template/document stored in a storage device associated with the pull-print server), and a passcode specific to the print job. In an example, the passcode specific to the print job may be manually generated via the print driver in response to triggering the print job. In another example, the passcode specific to the print job may be automatically generated and communicated to the client device (e.g., via an email, a notification, or the like) in response to triggering the print job.

Further, the pull-print server may identify the template corresponding to the reference identifier and store mapping information that maps the variable print data and the passcode to the identified template. When the pull-print server receives a pull print request including the passcode via a printer, the pull-print server may retrieve the variable print data and the stored template corresponding to the passcode using the mapping information. Further, the pull-print server may generate print content by overlaying the variable print data onto the identified template and transmit the print content to the printer for printing. Thus, examples described herein may enable the pull-print server to store a copy of the template mapped to different variable data of multiple users and associated passcodes. Hence, examples described herein may enhance security of the document and also reduce storage space in the pull-print server.

In the following description, for purposes of explanation, numerous specific details are set forth in order to provide a thorough understanding of the present techniques. However, the example apparatuses, devices, and systems, may be practiced without these specific details. Reference in the specification to “an example” or similar language means that a particular feature, structure, or characteristic described may be included in at least that one example but may not be in other examples.

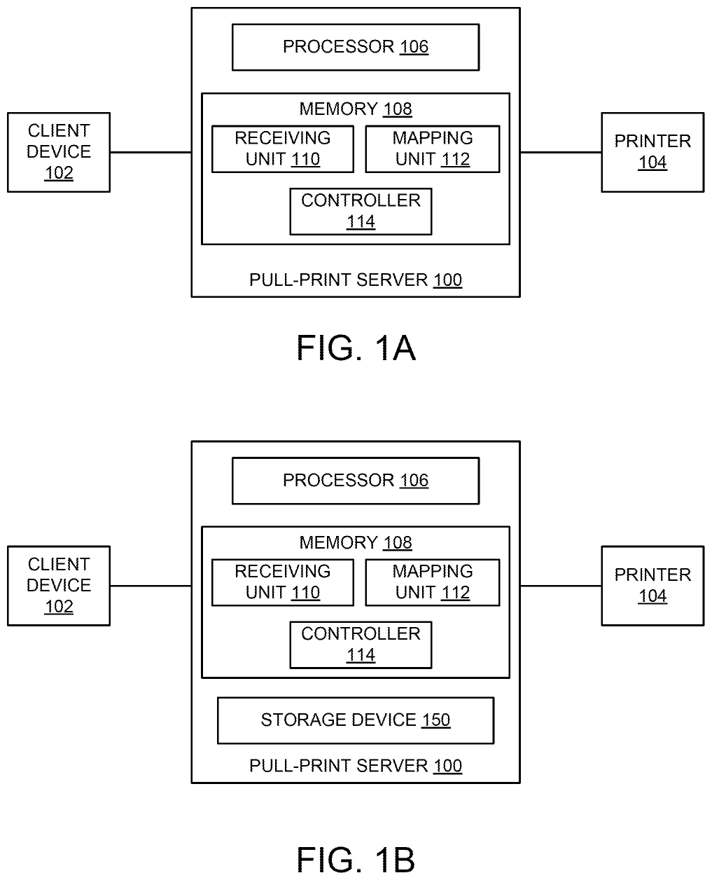

Turning now to the figures, FIG. 1A is a block diagram of an example pull-print server 100 to generate print content for printing based on a passcode. Example pull-print server 100 may be communicatively connected to a client device 102 and a printer 104 via a network. Example network may be a local area network (LAN), a wide area network (WAN), the Internet, and/or the like. A network printing environment of FIG. 1A is illustrated using client device 102 and printer 104, however, the network printing environment can include multiple client devices communicatively connected to multiple printers via pull-print server 100.

Example client device 102 may be an electronic device supporting a printing application to generate a print job and/or an email application to send/receive emails. For example, client device 102 may be a laptop, a desktop, a mainframe computer, a smartphone, a personal digital assistant (PDA), an Internet of Things (IoT) device, or the like. Further, client device 102 may include a print driver (e.g., to support the printing application) that is either installed in or accessible to client device 102 to generate the print job and send the print job for printing.

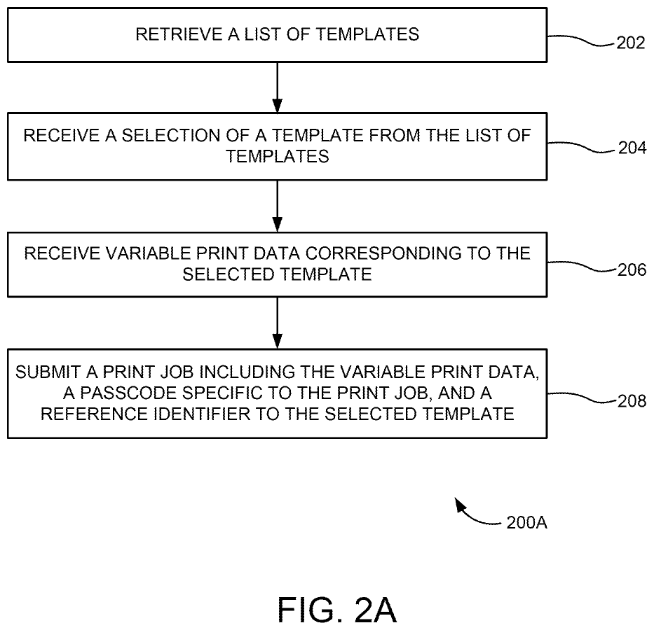

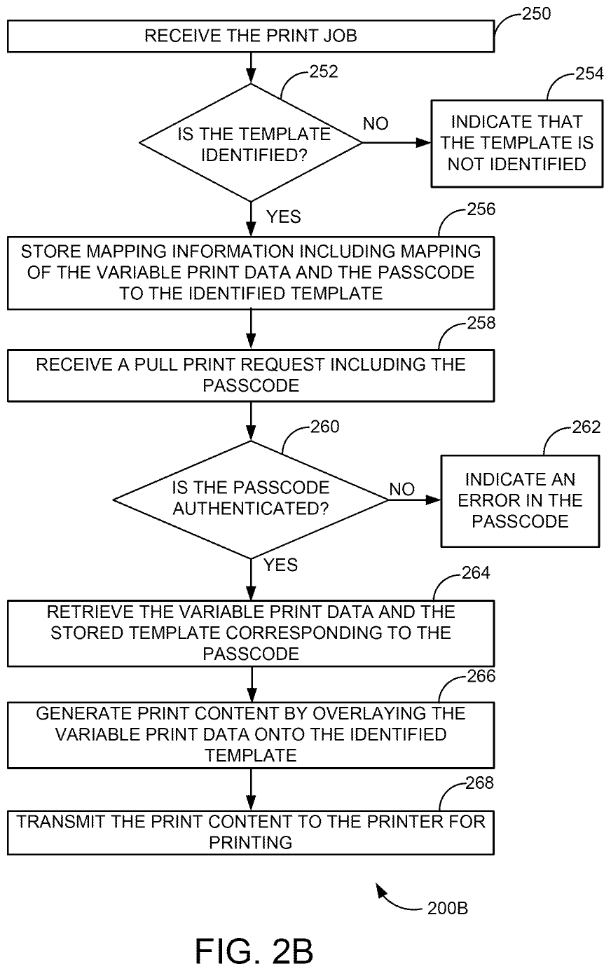

In an example, a user of client device 102 may retrieve a template or document stored in a storage device associated with pull-print server 100. An example template may be a file including pre-formatted content (i.e., static data). Further, the user may enter variable print data (i.e., user specific data) into the retrieved template. Upon entering the variable print data, the user may trigger a print job to print the filled-out template. Upon triggering the print job, the print driver running in client device 102 may dynamically generate a passcode corresponding to the print job. Further, the print driver may communicate the generated passcode to the user via an email, a message on a registered mobile phone, a notification on client device 102, or the like. Furthermore, the print driver may send the print job including the variable print data, a reference identifier corresponding to the template, and the passcode to pull-print server 100. An example process of generating the print job is described in FIG. 2A.

As shown in FIG. 1A, pull-print server 100 may include a processor 106 and a memory 108 coupled to processor 106. For example, processor 106 may be a type of central processing unit (CPU), microprocessor, or processing logic that interprets and executes machine-readable instructions stored in machine-readable storage medium in memory 108. Further, memory 108 may include a receiving unit 110, a mapping unit 112, and a controller 114.

During operation, receiving unit 110 may receive the print job via the print driver. Mapping unit 112 may identify a template corresponding to the reference identifier. For example, a list of templates accessible to pull-print server 100 may be parsed to identify the template corresponding to the reference identifier. Further, mapping unit 112 may store mapping information that maps the variable print data and the passcode to the identified template.

Controller 114 may receive a pull print request including the passcode, via printer 104 (e.g., via a user interface of printer 104). For example, when the user attempt to release the print job at printer 104, a prompt may be provided on a user interface of printer 104 to input the passcode. Upon receiving the passcode, printer 104 may communicate the passcode to pull-print server 100.

In response to receiving the pull print request and the passcode, controller 114 may retrieve the variable print data and the stored template corresponding to the passcode using the mapping information. In an example, controller 114 may authenticate the passcode associated with the pull print request using the mapping information and retrieve the variable data and the stored template corresponding to the passcode upon the authentication.

Further, controller 114 may generate print content by overlaying the variable print data onto the identified template. In an example, controller 114 may generate the print content by applying a rule for mapping the variable data and static data of the template to overlay the variable data onto the template. For example, with reference to the rule for mapping, mapping can be performed using keyword substitution in the variable print data into static print data in the template. In this example, keywords may be searched for in the static print data, and variable print data can be substituted in for those keywords. In an example, the variable print data and the rule may be defined by preferences of the print driver. Furthermore, controller 114 may transmit the print content to printer 104 for printing. Example printer 104 can be a laser beam printer (e.g., using an electrophotographic method for printing), an ink jet printer (e.g., using an ink jet method for printing), or the like.

In some examples, the functionalities described herein, in relation to instructions to implement functions of receiving unit 110, mapping unit 112, controller 114, and any additional instructions described herein in relation to the storage medium, may be implemented as engines or modules including any combination of hardware and programming to implement the functionalities of the modules or engines described herein. The functions of receiving unit 110, mapping unit 112, and controller 114 may also be implemented by processor 106. In examples described herein, processor 106 may include, for example, one processor or multiple processors included in a single device or distributed across multiple devices.

FIG. 1B is a block diagram of example pull-print server 100 of FIG. 1A, depicting additional features. Similarly named elements of FIG. 1B may be similar in function and/or structure to elements described in FIG. 1A. As shown in FIG. 1B, pull-print server 100 may include a storage device 150. In another example, storage device 150 may be external to pull-print server 100 and accessible to pull-print server 100. In an example, storage device 150 may store a list of templates. In another example, storage device 150 may store a document with multiple passwords. The document may include a plurality of segments with each segment being accessed using one of the multiple passwords. Further, the template may correspond to one of the segments.

FIG. 2A is a flowchart illustrating an example method 200A for generating a print job with an associated passcode. In an example, method 200A may be performed in a client device to generate the print job with the associated passcode. At 202, a list of templates may be retrieved from a storage device. In an example, the storage device may be associated with a pull-print server. A template or a form may be a file that may serve to generate a new document. The template may include pre-formatted content (i.e., static data) such as tags or placeholders that are to be filled in with variable data. The static data may be in a page description language.

At 204, a selection of a template from the retrieved list of templates may be received. For example, upon rendering the list of templates on a user interface of the client device, a user may select the template. In an example, the template may be password protected. Upon selection of the template, the user may be prompted to enter the password. Upon authenticating the password, the template may be displayed and/or accessible to the user.

At 206, variable print data corresponding to the selected template may be received. For example, the user may enter the variable print data (i.e., user-specific data) to fill the template. At 208, a print job including the variable data, a passcode specific to the print job, and a reference identifier to the selected template may be submitted to the pull-print server for printing by a print driver installed in or accessible to the client device.

FIG. 2B is a flowchart illustrating an example method 200B for generating print content in response to a request to release the print job with the associated passcode. In an example, method 200B may be executed in the pull-print server. In other examples, method 200B may be implemented in a printer (e.g., server-less pull printing). At 250, the print job may be received by the pull-print server. The print job may include the variable data, the passcode specific to the print job, and the reference identifier to the selected template.

At 252, a check may be made to determine whether the template corresponding to the reference identifier is present/identified in the storage device associated with the pull-print server. When the template corresponding to the reference identifier does not exist in the pull-print server, a notification to indicate that the template is not identified may be transmitted to the client device via an electronic message, at 254. An example electronic message may be a piece of digital communication that is designed or intended to be transmitted between the pull-print server and the client device such as an electronic mail, a text message, an instant message, or the like. When the template corresponding to the reference identifier is identified, at 256, mapping information including mapping of the variable print data and the passcode to the identified template may be stored. Thus, the user specific data and the passcode may be linked to the identified template.

At 258, a pull print request including the passcode may be received. At 260, a check may be made to determine whether the passcode is authenticated. When the passcode is not authenticated, a notification to indicate an error in the passcode may be displayed to the user via the user interface of the printer, for instance, at 262. When the passcode is authenticated, at 264, the variable print data and the stored template corresponding to the passcode may be retrieved. At 266, print content may be generated by overlaying the variable print data onto the identified template. At 268, the print content may be transmitted to the printer for printing. Thus, the variable print data corresponding to multiple users may be stored separately by mapping to the template with corresponding passcodes. Further, the print content (i.e., a combination of the variable print data and the template) may be generated and printed based on a corresponding passcode.

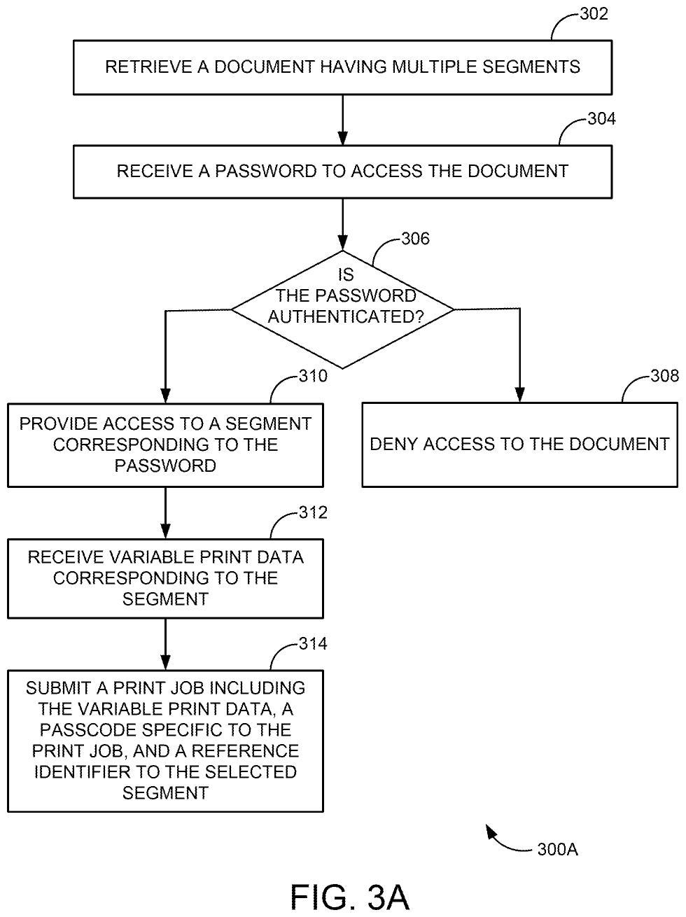

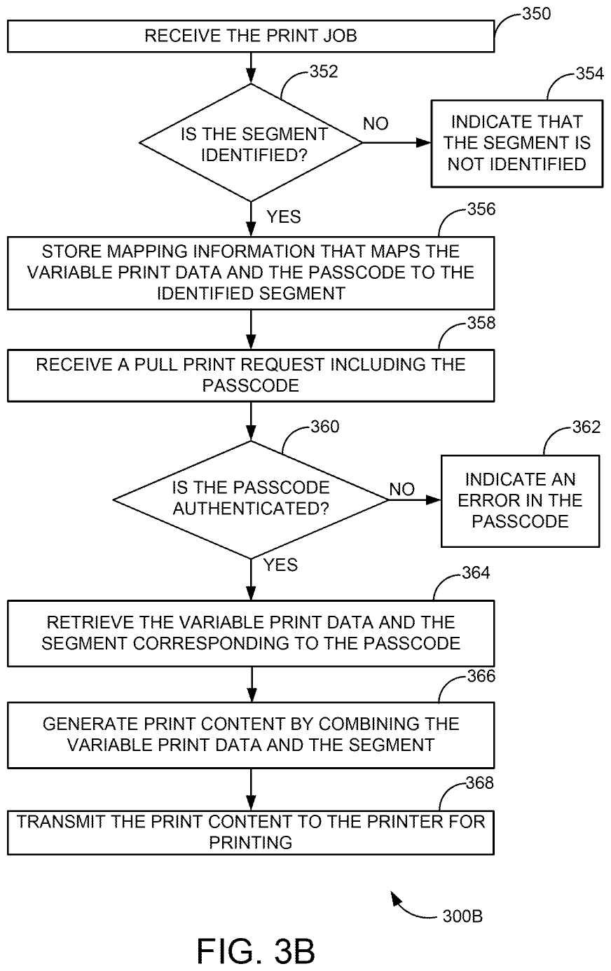

FIG. 3A is a flowchart illustrating another example method 300A for generating a print job with an associated passcode. In an example, method 300A may be performed in a client device to generate the print job and the associated passcode. At 302, a document having multiple segments may be retrieved from a storage device. In an example, the storage device may be associated with a pull-print server or a printer. For example, an administrator may store the document including a plurality of segments with different passwords. Each segment may be accessed using one of the multiple passwords. Further, the administrator may share the passwords to different user groups or users to enable the user groups or users to access the document, edit the document, or fill variable data in the document.

For example, consider a document with 4 pages. For a page range 1-3, the password may be set as ‘1s2d’ and communicated to user A (e.g., via an electronic message). Further, for a page rage 4-4, the password may be set as ‘3f4g’ and communicated to user B (e.g., via the electronic message). Similarly, another password can be generated for pages 3-4. In this example, when the password ‘1s2d’ is entered, pages 1-3 may be displayed to the user A for editing, printing, and the like. Similarly, when the password “3f4g” is entered, page 4 may be displayed to the user B for editing, printing, and the like. Hence, multiple users may access corresponding segments in the single document for editing, printing, and the like. Further, a single document may be maintained in the storage device to reduce a number of documents and also to facilitate in searching the document. Furthermore, multiple passwords for different segments of the document may enhance security of the document.

At 304, a password to access the document may be received. For example, a user may enter the password to edit a particular segment of the document. At 306, a check may be made to determine whether the entered password is authenticated (e.g., whether the entered password matches with one of the multiple passwords). When the password is not authenticated, access to the document may be denied, at 308. When the password is authenticated, at 310, an access to a segment corresponding to the password may be provided. Further, variable print data (i.e., user specific data) corresponding to the segment may be received, at 312. For example, the user may edit the segment to include the variable print data. At 314, a print job including the variable print data, a passcode specific to the print job, and a reference identifier to the selected segment may be submitted to the pull-print server for printing.

FIG. 3B is a flowchart illustrating an example method 300B for generating print content in response to a request to release the print job with the associated passcode. In an example, method 300B may be executed by the pull-print server or a printer. At 350, the print job may be received by the pull-print server. The print job may include the variable data, the passcode specific to the print job, and the reference identifier to the segment. At 352, a check may be made to determine whether a segment corresponding to the reference identifier exists in the storage device. When the segment corresponding to the reference identifier does not exist, a notification to indicate that the segment is not available may be transmitted to the client device, at 354.

When the segment corresponding to the reference identifier exists, at 356, mapping information including mapping of the variable print data and the passcode to an identified segment may be stored. At 358, a pull print request including a passcode may be received via a printer. At 360, a check may be made to determine whether the passcode is authenticated (i.e., to check whether the received passcode matches with the passcode associated with the print job). When the passcode is not authenticated, a notification to indicate an error in the passcode may be displayed to the user via a user interface of the printer, for instance, at 362.

When the passcode is authenticated, at 364, the variable print data and the segment corresponding to the passcode may be retrieved. At 366, print content may be generated by combining the variable print data and the segment. At 368, the generated print content may be transmitted to the printer for printing.

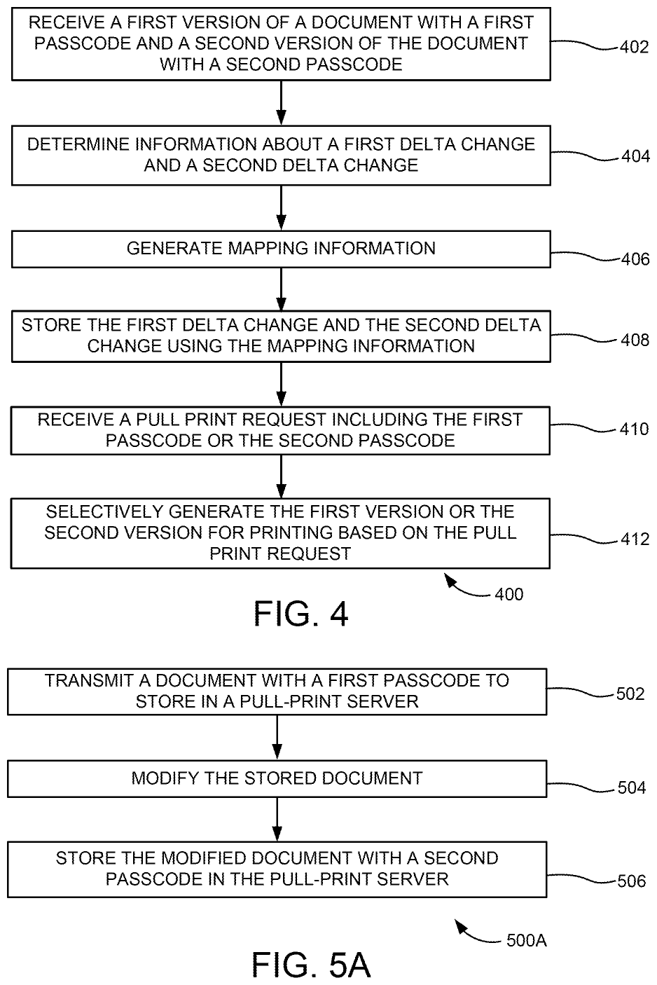

FIG. 4 is a flowchart illustrating an example method 400 for selectively generating a first version or a second version of a document for printing based on a corresponding passcode. In an example, method 400 may be implemented in a pull-print server or a printer. At 402, a first version of a document with a first passcode and a second version of the document with a second passcode may be received from a user account. In an example, the document may be stored on a storage device associated with the pull-print server. Further, the first version of the document with the first passcode and the second version of the document with the second passcode may be received from a client device via a printer application or an email. For example, the pull-print server may support printing through email. This enables the user to send an email to the pull-print server with the first and second versions and associated passcodes.

At 404, information about a first delta change and a second delta change may be determined in the first version and the second version, respectively, compared to the stored document. At 406, mapping information indicative of a mapping between the first delta change, second delta change, first passcode, second passcode, and/or stored document may be generated. In an example, generating the mapping information may include generating the mapping information indicative of:
an association between the first delta change, first passcode, and stored document, and
an association between the second delta change, second passcode, and stored document.

At 408, the first delta change and the second delta change may be stored using the mapping information. At 410, a pull print request including the first passcode or the second passcode may be received via a printer. At 412, the first version or the second version may be selectively generated for printing using the stored document, first delta change, and/or second delta change based on the pull print request. Further, the generated first version or the generated second version may be transmitted to the printer for printing. In an example, selectively generating the first version or the second version of the document for printing may include:
retrieving the stored document and the first delta change mapped to the first passcode when the pull print request includes the first passcode, and
generating the first version using the retrieved document and the first delta change.
In another example, selectively generating the first version or the second version of the document for printing may include:
retrieving the stored document and the second delta change mapped to the second passcode when the pull print request includes the second passcode, and
generating the second version using the retrieved document and the second delta change.

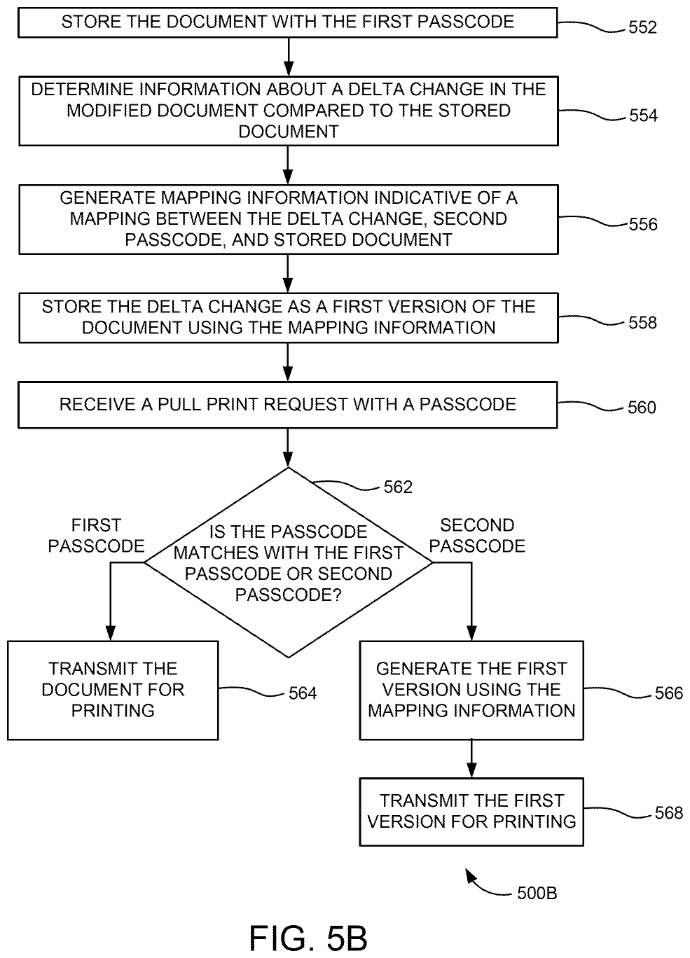

FIG. 5A is a flowchart illustrating an example method 500A for providing different versions of a document and associated passcodes to a pull-print server. At 502, a document with an associated first passcode may be transmitted to the pull-print server to store in a storage device associated with the pull-print server, for instance. At 504, a user may modify the stored document in the pull-print server. For example, the user may select the stored document and modify the selected document. At 506, the modified document with a second passcode may be stored in the pull-print server. Further, a process of storing the modified document with the second passcode in the pull-print server is described in FIG. 5B.

FIG. 5B is a flowchart illustrating an example method 500B for storing the different versions of the document of FIG. 5A for printing based on the associated passcodes. At 552, the document with the first passcode may be stored against a user account. Upon receiving the modified document (i.e., a version of the stored document) with the second passcode, the pull-print server may determine information about a delta change in the modified document compared to the stored document, at 554.

At 556, mapping information indicative of a mapping between the delta change, second passcode, and stored document may be generated. Further, the delta change may be stored using the mapping information corresponding to a first version of the document, at 558. At 560, a pull print request including a passcode may be received via a printer. At 562, a check may be made to determine whether the passcode matches with the first passcode or the second passcode. When the passcode matches with the first passcode, then the document may be transmitted for printing, at 564. In another example, when the passcode matches with the second passcode, the first version of the document (i.e., the modified document) may be generated using the mapping information (i.e., the document and the first delta change), at 566. Further, the generated first version may be sent to the printer for printing, at 568.

In an example, the methods 200A, 200B, 300A, 300B, 400, 500A, and 500B depicted in FIGS. 2A, 2B, 3A, 3B, 4, 5A, and 5B, respectively, may represent generalized illustrations, and that other processes may be added, or existing processes may be removed, modified, or rearranged without departing from the scope and spirit of the present application. In addition, the methods 200A, 200B, 300A, 300B, 400, 500A, and 500B may represent instructions stored on a computer-readable storage medium that, when executed, may cause a processor to respond, to perform actions, to change states, and/or to make decisions. The methods 200A, 200B, 300A, 300B, 400, 500A, and 500B may represent functions and/or actions performed by functionally equivalent circuits like analog circuits, digital signal processing circuits, application specific integrated circuits (ASICs), or other hardware components associated with the system. Furthermore, methods 200A, 200B, 300A, 300B, 400, 500A, and 500B may not be intended to limit the implementation of the present application, but rather example methods 200A, 200B, 300A, 300B, 400, 500A, and 500B may illustrate functional information to design/fabricate circuits, generate machine-readable instructions, or use a combination of hardware and machine-readable instructions to perform the illustrated processes.

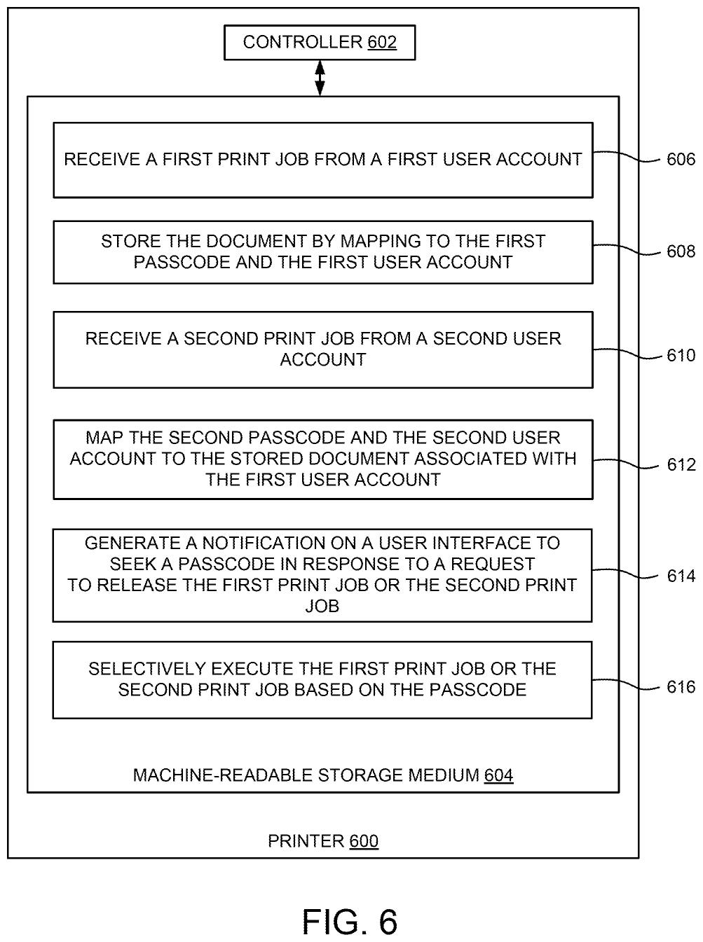

FIG. 6 is a block diagram of an example printer 600 including non-transitory machine-readable storage medium 604 storing instructions to store a document for printing by mapping to multiple passcodes and multiple user accounts. Printer 600 may include a processor 602 and machine-readable storage medium 604 communicatively coupled through a system bus. Processor 602 may be any type of central processing unit (CPU), microprocessor, or processing logic that interprets and executes machine-readable instructions stored in machine-readable storage medium 604.

Machine-readable storage medium 604 may be a random-access memory (RAM) or another type of dynamic storage device that may store information and machine-readable instructions that may be executed by processor 602. For example, machine-readable storage medium 604 may be synchronous DRAM (SDRAM), double data rate (DDR), rambus DRAM (RDRAM), rambus RAM, etc., or storage memory media such as a floppy disk, a hard disk, a CD-ROM, a DVD, a pen drive, and the like. In an example, machine-readable storage medium 604 may be non-transitory machine-readable medium. Machine-readable storage medium 604 may be remote but accessible to printer 600.

As shown in FIG. 6, machine-readable storage medium 604 may store instructions 606-616. In an example, instructions 606-616 may be executed by processor 602 to store a document for printing by mapping to multiple passcodes and multiple user accounts. Instructions 606 may be executed by processor 602 to receive a first print job from a first user account. An example first print job may include a document to be printed and a first passcode. Instructions 608 may be executed by processor 602 to store the document by mapping to the first passcode and the first user account.

Instructions 610 may be executed by processor 602 to receive a second print job from a second user account. An example second print job may include the document and a second passcode. Instructions 612 may be executed by processor 602 to map the second passcode and the second user account to the stored document associated with the first user account. In an example, instructions to map the second passcode and the second user account to the stored document associated with the first user account may include instructions to:
compare the document associated with the second print job with the stored document associated with the first user account, and
map the second passcode and the second user account to the stored document associated with the first user account when the document associated with the second print job matches with the stored document.

Instructions 614 may be executed by processor 602 to generate a notification on a user interface to seek a passcode in response to a request to release the first print job or the second print job. Instructions 616 may be executed by processor 602 to selectively execute the first print job or the second print job based on the passcode. In an example, instructions to execute the first print job or the second print job based on the passcode may include instructions to:
print the document when the passcode matches with the first passcode, and
delete mapping of the first passcode and the first user account to the stored document.

In another example, instructions to execute the first print job or the second print job based on the passcode may include instructions to:

- print the document when the passcode matches with the second passcode, and - delete mapping of the second passcode and the second user account to the stored document.

Further, machine-readable storage medium 604 may store instructions to delete the stored document when the mapping of the first passcode and the second passcode to the stored document are deleted. In the example shown in FIG. 6, instructions 606-616 are described as implemented using printer 600, however, instructions 606-616 can also be implemented in a pull-print server that is communicatively connected to printer 600.

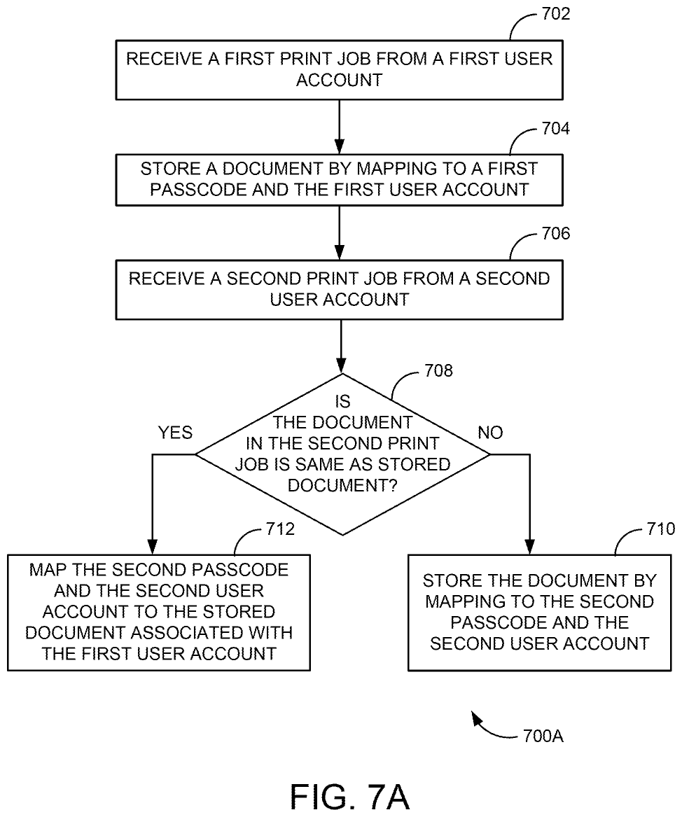

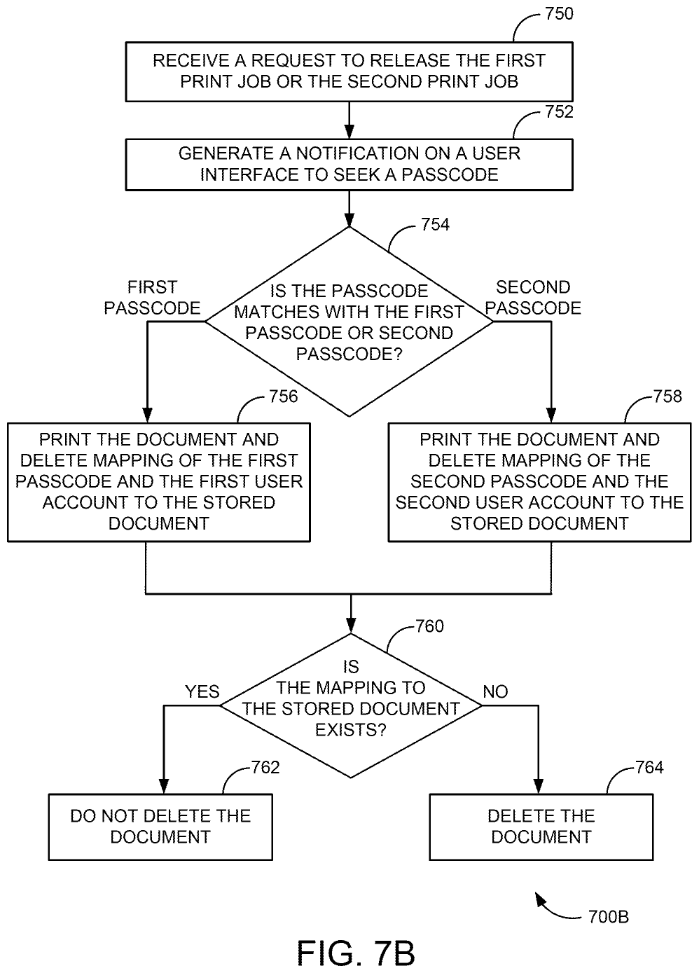

FIG. 7A is a flowchart illustrating an example method 700A for storing a document by mapping to multiple passcodes and multiple user accounts. At 702, a first print job may be received from a first user account. For example, the first print job may include a document to be printed and a first passcode (e.g., 1111). At 704, store the document associated with the first print job by mapping to the first passcode (e.g., 1111) and the first user account.

At 706, a second print job may be received from a second user account. For example, the second print job may include the document to be printed and a second passcode (e.g., 2222). At 708, a check may be made to determine whether the document in the second print job is same as the stored document corresponding to the first user account. When the document in the second print job is not same as the stored document corresponding to the first user account, the document corresponding to the second print job may be stored by mapping to the second passcode (e.g., 2222) and the second user account, at 710.

When the document in the second print job is same as the stored document corresponding to the first user account, the second passcode (e.g., 2222) and the second user account may be mapped to the stored document associated with the first user account, at 712. For example, consider a document A is stored in the storage device corresponding to user account A with passcode “1111”. When user B wants to store the document A to the storage device with passcode “2222”, then instead of storing the new document, document A will be maintained with user B details (e.g., passcode 2222). Thus, the incoming document from a user may be checked with the already stored documents associated with different user accounts and when the incoming document matches with any of the stored documents then, instead of separately storing the incoming document, a reference to the stored document may be created corresponding to the user's account, to reduce the storage space.

FIG. 7B is a flowchart illustrating an example method 700B for executing a print job (e.g., the first print job or the second print job of FIG. 7A) in response to a request to release the print job with an associated passcode. At 750, a request to release the first print job or the second print job may be received. Upon receiving the request to release one of the first print job and the second print job, a notification may be generated on a user interface of a printer to enter a passcode, at 752.

At 754, a check may be made to determine whether the passcode matches with the first passcode or second passcode. When the passcode matches with the first passcode, the document may be printed, and mapping of the first passcode and the first user account to the stored document may be deleted, at 756. When the passcode matches with the second passcode, the document may be printed, and mapping of the second passcode and the second user account to the stored document may be deleted, at 758.

At 760, a check may be made to determine whether the mapping associated with the stored document exists. When the mapping exists, the stored document may not be deleted, at 762. When the mapping to the stored document does not exist (i.e., when no other user shares the stored document), the stored document may be deleted, at 764.

In an example, the methods 700A and 700B depicted in FIGS. 7A and 7B, respectively, may represent generalized illustrations, and that other processes may be added, or existing processes may be removed, modified, or rearranged without departing from the scope and spirit of the present application. In addition, the methods 700A and 700B may represent instructions stored on a computer-readable storage medium that, when executed, may cause a processor to respond, to perform actions, to change states, and/or to make decisions. The methods 700A and 700B may represent functions and/or actions performed by functionally equivalent circuits like analog circuits, digital signal processing circuits, application specific integrated circuits (ASICs), or other hardware components associated with the system. Furthermore, methods 700A and 700B may not be intended to limit the implementation of the present application, but rather example methods 700A and 700B may illustrate functional information to design/fabricate circuits, generate machine-readable instructions, or use a combination of hardware and machine-readable instructions to perform the illustrated processes.

The above-described examples are for the purpose of illustration. Although the above examples have been described in conjunction with example implementations thereof, numerous modifications may be possible without materially departing from the teachings of the subject matter described herein. Other substitutions, modifications, and changes may be made without departing from the spirit of the subject matter. Also, the features disclosed in this specification (including any accompanying claims, abstract, and drawings), and/or any method or process so disclosed, may be combined in any combination, except combinations where some of such features are mutually exclusive.

The terms “include,” “have,” and variations thereof, as used herein, have the same meaning as the term “comprise” or appropriate variation thereof. Furthermore, the term “based on”, as used herein, means “based at least in part on.” Thus, a feature that is described as based on some stimulus can be based on the stimulus or a combination of stimuli including the stimulus. In addition, the terms “first” and “second” are used to identify individual elements and may not meant to designate an order or number of those elements.

The present description has been shown and described with reference to the foregoing examples. It is understood, however, that other forms, details, and examples can be made without departing from the spirit and scope of the present subject matter that is defined in the following claims.

What is claimed is:

1. A pull-print server comprising:
a processor; and
a memory coupled to the processor, wherein the memory comprises:
a receiving unit to receive, via a print driver running in a client device, a print job including variable print data, a reference identifier, and a passcode specific to the print job;
a mapping unit to:
identify a template corresponding to the reference identifier; and
store mapping information that maps the variable print data and the passcode to the identified template; and
a controller to:
receive, via a printer, a pull print request including the passcode;
in response to receiving the pull print request, retrieve the variable print data and the stored template corresponding to the passcode using the mapping information;
generate print content by overlaying the variable print data onto the identified template; and
transmit the print content to the printer.

2. The pull-print server of claim 1, wherein the controller is to:
authenticate the passcode associated with the pull print request using the mapping information; and
retrieve the variable data and the stored template corresponding to the passcode upon the authentication.

3. The pull-print server of claim 1, wherein the controller is to:
generate the print content by applying a rule for mapping the variable data and static data of the template to overlay the variable data onto the template.

4. The pull-print server of claim 1, further comprising:
a storage device to store a document with multiple passwords, wherein the document includes a plurality of segments with each segment being accessed using one of the multiple passwords, and wherein the template corresponds to one of the plurality of segments.

5. The pull-print server of claim 1, wherein the passcode specific to the print job is generated via the print driver running in the client device in response to triggering the print job.

6. A method comprising:
receiving a first version of a document with a first passcode and a second version of the document with a second passcode from a user account, wherein the document is stored on a storage device;
determining information about a first delta change and a second delta change in the first version and the second version, respectively, compared to the stored document;
generating mapping information indicative of a mapping between the first delta change, second delta change, first passcode, second passcode, and/or stored document;
storing the first delta change and the second delta change using the mapping information;
receiving, via a printer, a pull print request including the first passcode or the second passcode; and
based on the pull print request, selectively generating the first version or the second version for printing using the stored document, first delta change, and/or second delta change.

7. The method of claim 6, further comprising:
transmitting the generated first version or the generated second version to the printer for printing.

8. The method of claim 6, wherein generating the mapping information comprises:
generating the mapping information indicative of:
an association between the first delta change, first passcode, and stored document; and
an association between the second delta change, second passcode, and stored document

9. The method of claim 6, wherein selectively generating the first version or the second version of the document for printing comprises:
when the pull print request includes the first passcode:
retrieving the stored document and the first delta change mapped to the first passcode; and
generating the first version using the retrieved document and the first delta change.

10. The method of claim 6, wherein selectively generating the first version or the second version of the document for printing comprises:
when the pull print request includes the second passcode:
retrieving the stored document and the second delta change mapped to the second passcode; and
generating the second version using the retrieved document and the second delta change.

11. The method of claim 6, wherein the first version of the document with the first passcode and the second version of the document with the second passcode are received from a client device via a printer application or an email.

12. A non-transitory computer-readable storage medium encoded with instructions that, when executed by a processor of a printer, cause the processor to:
receive a first print job from a first user account, the first print job comprising a document to be printed and a first passcode;
store the document by mapping to the first passcode and the first user account;
receive a second print job from a second user account, the second print job comprising the document and a second passcode;
map the second passcode and the second user account to the stored document associated with the first user account;
in response to a request to release the first print job or the second print job, generate a notification on a user interface to seek a passcode; and
selectively execute the first print job or the second print job based on the passcode.

13. The non-transitory computer-readable storage medium of claim 12, wherein instructions to execute the first print job or the second print job based on the passcode comprise instructions to:
when the passcode matches with the first passcode,
print the document;
delete mapping of the first passcode and the first user account to the stored document; and
when the passcode matches with the second passcode,
print the document; and
delete mapping of the second passcode and the second user account to the stored document.

14. The non-transitory computer-readable storage medium of claim 13, further comprising instructions to:
delete the stored document when the mapping of the first passcode and the second passcode to the stored document are deleted.

15. The non-transitory computer-readable storage medium of claim 12, wherein instructions to map the second passcode and the second user account to the stored document associated with the first user account comprises instructions to:
compare the document associated with the second print job with the stored document associated with the first user account; and
map the second passcode and the second user account to the stored document associated with the first user account when the document associated with the second print job matches with the stored document.
